(19) United States
(12) Patent Application Publication
(10) Pub. No.: US 2017/0006535 A1
(43) Pub. Date: Jan. 5, 2017

(54) NETWORK SELECTION BASED ON USER FEEDBACK

(71) Applicant: QUALCOMM Incorporated, San Diego, CA (US)

(72) Inventors: Lochan Verma, San Diego, CA (US); Vijayalakshmi Rajasundaram Raveendran, San Diego, CA (US)

(21) Appl. No.: 14/789,308

(22) Filed: Jul. 1, 2015

(51) Int. Cl. H04W 48/18; H04W 48/16; H04W 48/20; H04W 74/06; H04W 24/10; H04W 76/02; H04W 24/02

(52) U.S. Cl. CPC H04W 48/18; H04W 76/02; H04W 48/16; H04W 24/02; H04W 74/06; H04W 24/10; H04W 48/20; H04W 88/10

(57) ABSTRACT

In one example, a method includes determining a plurality of wireless networks currently accessible by a device, and receiving, by the device and for one or more respective wireless networks of the plurality of wireless networks, a metric based on user feedback about connection experiences with the respective wireless network. In this example, the method also includes outputting, by the device, a graphical user interface (GUI) including the respective metrics for the one or more wireless networks, and receiving, by the device, an indication of user input, the user input indicating a selection of a particular wireless network of the one or more wireless networks. In this example, the method also includes establishing, by the device, a connection with the particular wireless network.

### TECHNICAL FIELD

This disclosure relates to techniques for selection of wireless networks.

### BACKGROUND

In many situations, a device may be able to connect to several different networks. For instance, at a particular time, a device may be able to connect to one or more cellular (e.g., LTE, 3G, 4G, etc.) networks and one or more Wi-Fi networks. The device may determine respective signal strengths for each of the networks. While the signal strengths may be determined in terms of signal to noise ratio (SNR), the device may present the strengths in a more user-friendly mode, such as 1 to 5 “bars.” For instance, the device may present a user of the device with a list of the networks along with a signal strength in “bars.” Using the signal strength representation, a user may select a particular network for connection.

### SUMMARY

In general, this disclosure describes techniques for enabling a device, or a user of the device, to select and connect to a wireless network based on feedback (e.g., social feedback) about connection experiences with the wireless network.

In one example, a method for enabling selection of a wireless network includes determining, by a device, a plurality of wireless networks currently accessible by the device; receiving, by the device and for one or more respective wireless networks of the plurality of wireless networks, a metric based on user feedback about connection experiences with the respective wireless network; outputting, by the device, a graphical user interface (GUI) including the respective metrics for the one or more wireless networks; receiving, by the device, an indication of user input, the user input indicating a selection of a particular wireless network of the one or more wireless networks; and establishing, by the device, a connection with the particular wireless network.

In another example, a device includes one or more wireless communication modules; and one or more processors configured to: determine a plurality of wireless networks currently accessible by the device; receive, for one or more respective wireless networks of the plurality of wireless networks, a metric based on user feedback about connection experiences with the respective wireless network; output a GUI including the respective metrics for the one or more wireless networks; receive an indication of user input, the user input indicating a selection of a particular wireless network of the one or more wireless networks; and establish a connection with the particular wireless network.

In another example, a device includes means for determining a plurality of wireless networks currently accessible by the device; means for receiving, for one or more respective wireless networks of the plurality of wireless networks, a metric based on user feedback about connection experiences with the respective wireless network; means for outputting a GUI including the respective metrics for the one or more wireless networks; means for receiving an indication of user input, the user input indicating a selection of a particular wireless network of the one or more wireless networks; and means for establishing a connection with the particular wireless network.

In another example, a non-transitory computer-readable storage medium stores instructions that, when executed, cause one or more processors of a device to: determine a plurality of wireless networks currently accessible by the device; receive, for one or more respective wireless networks of the plurality of wireless networks, a metric based on user feedback about connection experiences with the respective wireless network; output a GUI including the respective metrics for the one or more wireless networks; receive an indication of user input, the user input indicating a selection of a particular wireless network of the one or more wireless networks; and establish a connection with the particular wireless network.

In one example, a method for enabling selection of a wireless network includes outputting, to a device and by an access point of a wireless network currently accessible by the device, a metric based on user feedback about connection experiences with the wireless network.

In another example, a wireless access point includes one or more wireless communication modules; and one or more processors configured to: host, via the one or more wireless communication modules, a wireless network that is currently accessible by a device; and output, to the device and via the one or more wireless communication modules, a metric based on user feedback about connection experiences with the wireless network.

In another example, a device includes means for hosting a wireless network that is currently accessible by a device; and means for outputting, to the device and via the one or more wireless communication modules, a metric based on user feedback about connection experiences with the wireless network.

In another example, a non-transitory computer-readable storage medium stores instructions that, when executed, cause one or more processors of a wireless access point to: output, to a device and by an access point of a wireless network currently accessible by the device, a metric based on user feedback about connection experiences with the wireless network.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram of an example environment in which a plurality of wireless network access points are currently accessible by a device, in accordance with one or more techniques of this disclosure.

FIG. 2 is a block diagram illustrating further details of one example of an access point of FIG. 1, in accordance with one or more techniques of this disclosure.

FIG. 3 is a block diagram illustrating further details of one example of a device of FIG. 1, in accordance with one or more techniques of this disclosure.

FIG. 4 is a flow diagram illustrating example operations of an access point to enable a device to connect to a wireless network hosted by the access point based on user feedback about connection experiences with the wireless network, in accordance with one or more techniques of this disclosure.

FIG. 5 is a flow diagram illustrating example operations of a device to connect to a wireless network hosted by an access point based on user feedback about connection experiences with the wireless network, in accordance with one or more techniques of this disclosure.

### DETAILED DESCRIPTION

This disclosure describes techniques for enabling a device, or a user of the device, to select and connect to a wireless network based on feedback (e.g., social feedback) about connection experiences with the wireless network. For example, in an environment where multiple wireless networks are currently accessible by a device, such as an airport, a user of the device may want the device to connect to one of the wireless networks (e.g., to access one or more services provided by via the wireless network, such as the Internet).

The user's device may determine a plurality of wireless networks that are currently accessible by the device and output a user interface (UI) that includes information about the currently available wireless networks (e.g., wireless networks A, B, and C), such as network name, and signal strength. Table 1, below, illustrates one example of the information which may be included in the UI.

TABLE 1

| Network Name | Network Type | Signal Strength |
|---|---|---|
| A | Wi-Fi | 90% |
| B | Wi-Fi | 70% |
| C | LTE | 70% |

In some examples, the user may cause the device to connect to network “A” as it has the strongest signal strength. However, user experience is subjective and the user may or may not be satisfied with the connection experience (e.g., due to latencies and lags experienced by the user) while surfing the web and/or watching multimedia online with network “A”. In other words, highest signal strength does not imply best service (i.e., the signal strength of the network may not correlate with a connection experience of the network). For instance, although the device may have a signal strength of 90% with network “A” and 70% network “B”, a connection experience with network “B” may be superior to a connection experience with network “A” (e.g., if an access point of network “B” has a faster connection to the Internet and/or is less congested that an access point of network “A”). The user may spread the word that network “A” is good/bad/so-so or just keep quiet. Therefore, it may be desirable to enable the user to select a network based on more than just signal strength.

Today, the concept of social feedback, such as “Likes,” is pervasive as a result of social media such as Facebook, Instagram, Yelp. In some examples, social feedback may influence certain decisions. For instance, some people may prefer to visit restaurants with more stars on Yelp. In accordance with one or more techniques of this disclosure, as opposed to selecting a network based on signal strength, the user's device may output a UI that includes a metric based on feedback (e.g., Likes) about connection experiences with the networks. Table 2, below, illustrates one example of the information which may be included in the UI.

TABLE 2

| Network | | | |
|---|---|---|---|
| Name | Network Type | Signal Strength | Likes |
| A | Wi-Fi | 90% | 2k |
| B | Wi-Fi | 70% | 15k |
| C | LTE | 70% | 10k |

The inclusion of the social metric may enable network selection based on social feedback about other user's connection experiences with the wireless networks. For instance, while network “A” may have the strongest signal, it has the lowest Likes (2,000). As such, the user may cause the device to connect to network “B” because, while it has a weaker signal, it has more than seven times the number of Likes (15,000). In this way, techniques of this disclosure enable network selection based on more than just signal strength.

While the device is connected to network “B,” the user may be prompted to provide feedback regarding the user's connection experience with network “B.” For instance, the device may output a UI to enable the user to indicate whether they Like network “B.” In some examples, the user also may be able to indicate whether they Dislike network “B.” In some examples, as opposed to using a binary metric such as Likes, the user may provide feedback on a 1-5 scale or other such rating system. The device may send data indicating the user's feedback (regarding the user's connection experience with network “B”) to an external device, such as a server or an access point hosting network “B”. The external device may use the data to update the metric for network “B.” In this way, a metric for a wireless network may be determined based on user feedback about connection experiences with the wireless network.

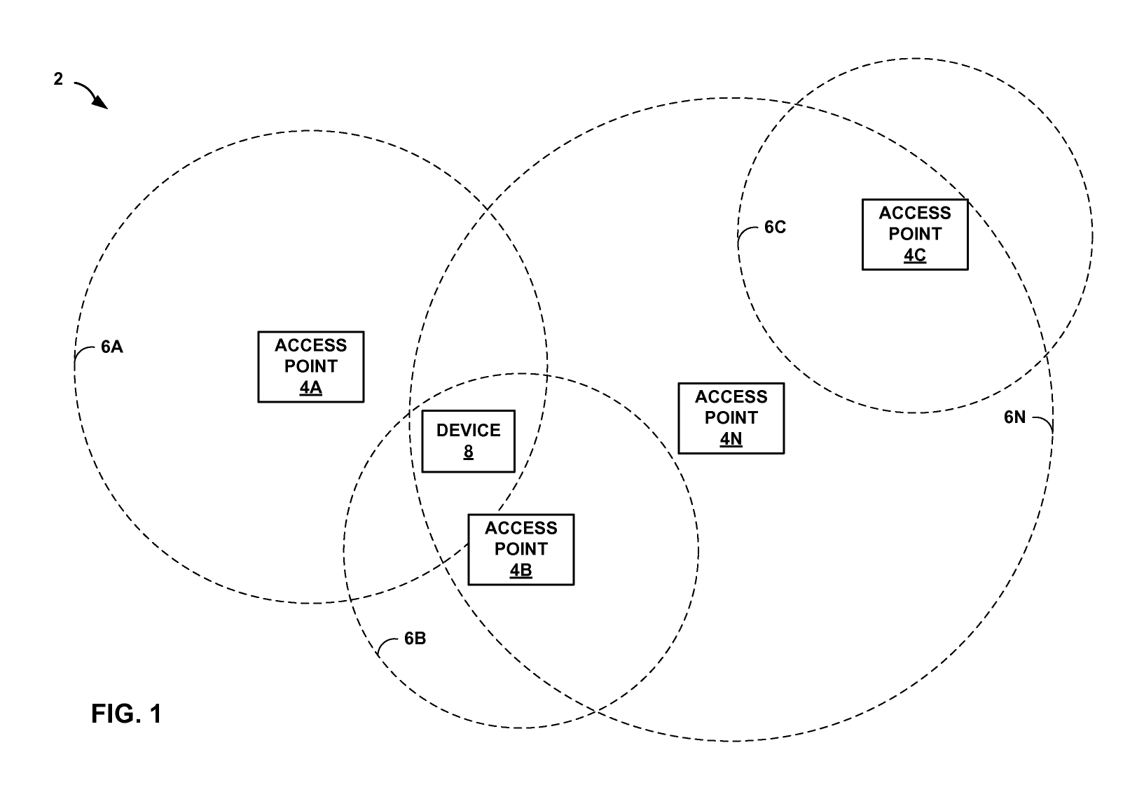

FIG. 1 is a conceptual diagram of an example environment in which a plurality of access points are currently accessible by a device, in accordance with one or more techniques of this disclosure. As illustrated in FIG. 1, environment 2 may include a plurality of access points (APs) 4A-4N (collectively, “APs 4”) with respective coverage areas 6A-6N (collectively, “coverage areas 6”), and device 8.

Environment 2 may include APs 4, which may each host (e.g., transmit and receive signals for) one or more wireless networks. In some examples, each of APs 4 may host a different wireless network. For instance, AP 4A may host a first wireless network, AP 4B may host a second wireless network, . . . , and AP 4N may host an N^{th} wireless network. In some examples, two or more of APs 4 may host a same network. For instance, AP 4A and AP 4C may both host a same network.

In some examples, one or more of the wireless networks hosted by APs 4 may be connected to a Wide Area Network (WAN), such as the Internet. In such examples, resources connected to the WAN (e.g., web pages, Internet connected servers, video streaming services, etc.) may all be accessible via any of the wireless networks connected to the WAN.

In some examples, APs 4 may be associated with different types of APs, such as cellular networks and Wi-Fi APs. As such, in some examples, the networks hosted by APs 4 may be considered to be heterogeneous networks (HetNets). Examples, of cellular APs include, but are not limited to, 5G APs (e.g., Next Generation Mobile Networks Alliance (NGMN) APs), 4G APs (e.g., Long-Term Evolution (LTE) APs, LTE networks operating in unlicensed spectrum (LTE-U) APs, WiMAX APs), and 3G APs (e.g., Universal Mobile Telecommunication System (UMTS) APs, Enhanced Data Rates for GSM Evolution (EDGE) APs, CDMA2000) APs). Access points of access points 4 that are cellular APs may be referred to as cell sites, microcells, femtocells, picocells, or the like. Examples of Wi-Fi APs include, but are not limited to, any wireless local area network (WLAN) AP, such as APs operating in compliance with the IEEE 802.11 series of standards (available at http://standards.ieee.org/about/get/802/802.11.html). Regardless of the type of associated network, APs 4 may be alternatively referred to as base stations. In some examples, one or more of APs 4 may be referred to as a small cell. For instance, an AP of APs 4 with a range less than a threshold (e.g., 10 meters, 1 kilometer, 2 kilometers) may be referred to as a small cell. In some examples, one or more of APs 4 may be referred to as a macrocell. For instance, an AP of APs 4 with a range greater than the threshold (e.g., 10 meters, 1 kilometer, 2 kilometers) may be referred to as a small cell.

As illustrated in FIG. 1, each of APs 4 may have a respective coverage area of coverage areas 6. In some examples, coverage areas 6 may represent the respective physical locations in which a device, such as device 8, may be located and still access (e.g., receive signals from and/or transmit signals to) the respective AP of APs 4. For instance, a device located within coverage area 6A may be able to access AP 4A. In the example of FIG. 1, device 8 may be located within coverage areas 6A, 6B, and 6N and device 8 may be outside of coverage area 6C. As such, in the example of FIG. 1, device 8 may be able to access APs 4A, 4B, and 4N, but may not be able to access AP 4C. As should be understood, the APs accessible to device 8 may change if the physical location of device 8 changes. For instance, if device 8 moves (with reference to the page) up and to the right, device 8 may lose access to APs 4A and 4B but may, if moved within coverage area 6C, gain access to AP 4C.

Environment 2 may include device 8, which may be capable of connecting to one or more wireless networks. In some examples, device 8 may be capable of connecting to different types of wireless networks, such as wireless networks hosted by cellular APs (i.e., cellular wireless networks) and wireless networks hosted by Wi-Fi APs (i.e., Wi-Fi wireless networks). Some examples of the types of APs which device 8 may be capable of connecting to are listed above with respect to APs 4. Examples of device 8 include, but are not limited to, mobile devices such as smartphones or other mobile handsets, tablet computers, laptop computers, one or more processing units or other integrated circuits or chip sets, or other electronic device.

In operation, device 8 may determine a plurality of wireless networks currently accessible by device 8. For instance, device 8 may perform one or more scanning/probing operations to generate a list of currently accessible wireless networks. In the example of FIG. 1, device 8 may determine that wireless networks hosted by APs 4A, 4B, and 4N are currently accessible. For purposes of explanation, the wireless network hosted by AP 4A will be referred to as wireless network A, the wireless network hosted by AP 4B will be referred to as wireless network B, . . . , and the wireless network hosted by AP 4N will be referred to as wireless network N.

In some examples, device 8 may determine a network type for one or more of the currently accessible wireless networks. In the example of FIG. 1, device 8 may determine that wireless network A and wireless network B are Wi-Fi wireless networks and that wireless network N is an LTE wireless network. In some examples, device 8 may determine a signal strength metric, such as a signal-to-noise ratio, for one or more of the currently accessible wireless networks. In the example of FIG. 1, device 8 may determine that the signal strength of wireless network A is 90%, wireless network B is 70%, and wireless network N is 70%.

As discussed above, in some examples, it may be desirable for a device to select, or enable a user of the device to select, a wireless network based on more than just signal strength. In accordance with one or more techniques of this disclosure, device 8 may select, or enable a user of device 8 to select, a wireless network of a plurality of wireless networks based on user feedback about connection experiences with the plurality of wireless networks. For instance, device 8 may receive, for one or more respective wireless networks of the plurality of wireless networks currently accessible by device 8, a metric based on user feedback about connection experiences with the respective wireless network.

As discussed above, the metric may be in the form of a number of likes, a number of dislikes, a 1-N (e.g., 1-5) scale, or any other similar rating system. In the example of FIG. 1, device 8 may receive data indicating a metric based on user feedback about connection experiences with wireless network A (e.g., 2,000 likes), a metric based on user feedback about connection experiences with wireless network B (e.g., 15,000 likes), and a metric based on user feedback about connection experiences with wireless network N (e.g., 10,000 likes). As such, in the example of FIG. 1, device 8 may determine the information shown above in Table 2.

In some examples, device 8 may receive the metrics for the respective wireless networks from APs of APs 4 hosting the respective wireless networks. For instance, device 8 may receive the metric for wireless network A from AP 4A, the metric for wireless network B from AP 4B, and the metric for wireless network N from AP 4N. In other examples, device 8 may receive metrics for two or more of the wireless networks from a single AP of APs 4. For instance, device 8 may receive the metrics for wireless network A, B, and C from AP 4A. In some examples, device 8 may receive the metrics using a combination of these techniques. For instance, device 8 may receive the metrics for wireless networks A and B from AP 4A, and receive the metric for wireless network N from AP 4N.

In some examples, such as the example of FIG. 1, device 8 may receive a metric for every currently accessible wireless network. In other examples, device 8 may not receive a metric for at least one of the currently accessible wireless networks. For instance, where a particular network is not configured to participate in the user feedback system, device 8 may not receive a metric for the particular network.

Device 8 may establish a connection with a particular network of the plurality of wireless networks. In some examples, device 8 may automatically select a network of the plurality of wireless networks for connection. In some examples, device 8 may enable a user of device 8 to select a network of the plurality of wireless networks for connection.

In some examples, to automatically select the network for connection, device 8 may select the network of the plurality of wireless networks with the metric that indicates the best connection experience. In the example of FIG. 1, device 8 may automatically select network B as network B has more likes (15,000 likes) than both network A (2,000 likes) and network N (10,000 likes). In this way, device 8 may automatically select a wireless network based on user feedback about connection experiences with the wireless network.

In some examples, to enable the user of device 8 to select the network for connection, device 8 may output a graphical user interface (GUI) including the respective metrics for the one or more wireless networks. For instance, device 8 may output a GUI that includes some or all of the information shown above in Table 2. The user of device 8 may review the GUI and provide user input indicating a selection of a particular wireless network of the one or more wireless networks. In the example of FIG. 1, the user input may indicate a selection of network B. Device 8 may receive an indication of the user input and determine the selected network based on the indication. In this way, device 8 may enable the user of device 8 to select a wireless network based on user feedback about connection experiences with the wireless network.

Device 8 may establish a connection with the selected wireless network. For instance, where the selected wireless network is network B, device 8 may establish a connection with AP 4B. In this way, device 8 may access one or more resources connected to network B (either directly connected to network B or connected to another network accessible via network B).

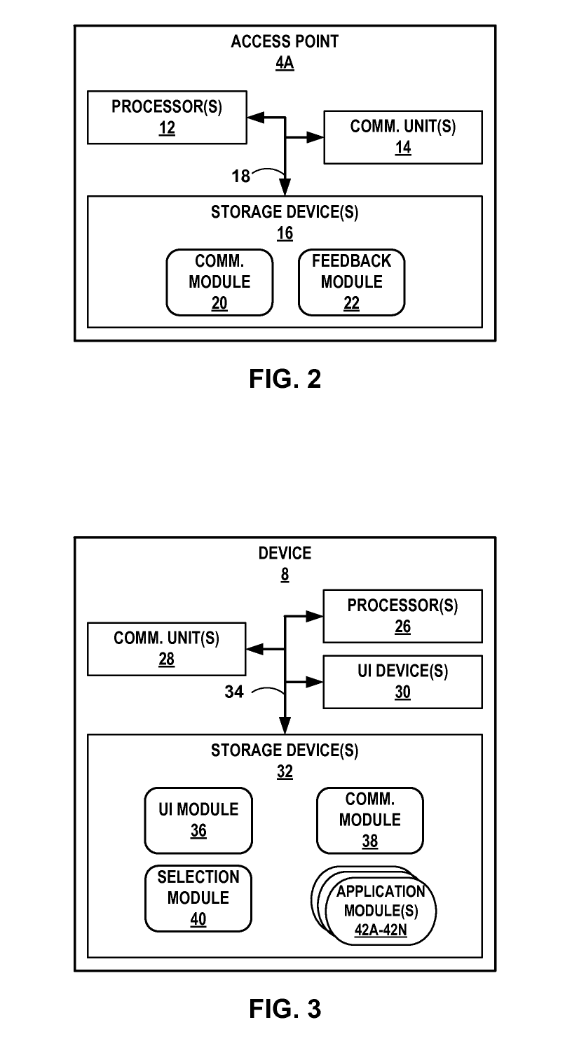

FIG. 2 is a block diagram illustrating further details of one example of an access point of FIG. 1, in accordance with one or more techniques of this disclosure. As illustrated in FIG. 2, AP 4A may include one or more processors 12, one or more communication units 14, and one or more storage devices 16. Each of components 12, 14, and 16 may be interconnected (physically, communicatively, and/or operatively) via communication channels 18 for inter-component communications. In some examples, communication channels 18 may include a system bus, network connection, interprocess communication data structure, or any other channel for communicating data. One or more of storage devices 16, in some examples, may include communication module 20, and feedback module 22.

Processors 12, in one example, are configured to implement functionality and/or process instructions for execution within AP 4A. For example, processors 12 may be capable of processing instructions stored in one or more of storage devices 16. Examples of processors 12 may include any one or more microprocessors, digital signal processors (DSPs), application specific integrated circuits (ASICs), field programmable gate arrays (FPGAs), or any other equivalent integrated or discrete logic circuitry, as well as any combinations of such components.

AP 4A, in some examples, also includes ones or more communication units 14. AP 4A may utilize one or more of communication units 14 to communicate with external devices via one or more networks, such as one or more wired or wireless networks. One or more of communication units 14 may be a network interface card, such as an Ethernet card, an optical transceiver, a radio frequency transceiver, or any other type of device that can send and receive information. Other examples of such network interfaces may include Bluetooth, cellular (e.g., 3G, 4G, 5G), and Wi-Fi radios. In some examples, communication unit 14 may receive input from other components of AP 4A, such as communication module 20, that causes communication unit 14 to wirelessly communicate with an external device.

AP 4A, in some examples, also includes, communication module 20. In some examples, upon execution by processor(s) 12, communication module 20 may manage communications between AP 4A and external devices. In some examples, communication module 20 may host one or more wireless networks. For instance, communication module 20 may host wireless network A (described above with reference to FIG. 1).

AP 4A, in some examples, also includes feedback module 22, which may facilitate dissemination and determination of a metric based on user feedback about connection experiences with wireless network A (i.e., a wireless network hosted by AP 4A). As one example, feedback module 22, upon execution by processor(s) 12, may cause communication module 20 to output, via one or more of communication units 14, the metric based on user feedback about connection experiences with wireless network A to a device, such as device 8 of FIG. 1. As another example, feedback module 22 may receive, from a device connected to wireless network A and via one or more of communication unit(s) 14, data indicating subjective evaluation, a user of the connected device, of a connection experience with wireless network A.

In some examples, feedback module 22 may determine the metric based on one or more variables in addition to the user feedback. For instance, feedback module 22 may determine the metric based on the user feedback and one or both of a distance between a device and AP 4A, and a data load on AP 4A. The data load on AP 4A may correspond to the number of megabytes per second (MB/s) passing through AP 4A. In some examples, feedback module 22 may maintain one or more look-up tables that map combinations of data load and distance to the metric. Table 3, below, is an example of a look-up table that may be maintained by feedback module 22. In some examples, the data loads and distances shown in Table 3 may be defined as ranges. For instance, like metric e may correspond to data loads less than or equal to x and distances less than or equal to a. Similarly, like metric s′ may correspond to data loads greater than x but less than or equal to x+y and distances greater than a but less than or equal to a′.

TABLE 3

| Data Load | Distance | Metric |
|---|---|---|
| x | a | e |
| | a′ | s |
| | a″ | k |
| x + y | a | e′ |
| | a′ | s′ |
| | a″ | k′ |
| x + y + x′ | a | e″ |
| | a′ | s″ |
| | a″ | k″ |

To determine the metric for a device, feedback module 22 may determine one or both of a distance between the device and AP 4A and a data load on AP 4A. As shown by Table 3, if the data load on AP 4A is x and the distance between AP 4A and the device is a, feedback module 22 may determine that the metric is e. Similarly, if the data load on AP 4A is x+y and the distance between AP 4A and the device is a, feedback module 22 may determine that the metric is e′. In this way, feedback module 22 may determine the metric based on one or more variables in addition to the user feedback.

To determine the metric based on a distance between AP 4A and the device, AP 4A may actually determine the distance. In some examples, AP 4A may determine the determine distance through ranging over IEEE 802.11, Bluetooth, or any other non-Wi-Fi mechanism. In some examples, AP 4A may infer the distance based on information, such as a strength of a signal received from the device. For instance, AP 4A may compare the strength of a signal received from the device with one or more look-up tables that map signal strengths to distances.

As stated above, feedback module 22 may receive, from a device connected to wireless network A and via one or more of communication unit 14, data indicating subjective evaluation, by a user of the connected device, of a connection experience with wireless network A. In accordance with one or more techniques of this disclosure, feedback module 22 may update the metric based on the received data. For instance, where the data indicates that the user of the device likes the connection experience and the metric is a number of likes, feedback module 22 may update the metric by incrementing the number of likes.

In some examples, such as where feedback module 22 determines the metric based on a data load on AP 4A, feedback module 22 may update the metric corresponding to the data load on AP 4A during an interval in which the user of the device indicated their subjective evaluation of a connection experience with wireless network A. In some examples, feedback module 22 may determine the data load on AP 4A during the interval in accordance with Equation (1) below, where i is an index of an interval of duration t, Nⁱ is the number of devices connected to AP 4A during interval i, rⱼⁱ is the data load from device j during interval i, and rⁱ is the total data load on AP 4A (from all users) during interval i.

$${r}^{i} = \frac{1}{t} {\sum }_{j = 0}^{{N}^{i}} {r}_{j}^{i} \qquad Equation ( 1 )$$

Feedback module 22 may update the metric in the look-up table (e.g., Table 3) corresponding to the data load on AP 4A during the interval. For instance, where the data load on AP 4A (rⁱ) is x, the data indicates that the user of the device likes the connection experience with AP 4A, and the distance between AP 4A and the device is a, feedback module 22 may increment the metric in the look-up table corresponding to data load x and distance a (i.e., metric e of Table 3). In some examples, feedback module 22 may update the look-up table at the end of each interval.

In some examples, as opposed to incrementing a previous metric, feedback module 22 may update the metric using a moving average. For instance, feedback module 22 may update the metric in accordance with Equation (2), below, where L^{c} is the updated metric, Lⁱ is the metric based on feedback during interval i, L^{p} is the metric after the previous update (i.e., the metric based on Lⁱ⁻¹) and α and β are weighting factors that sum to 1. In some examples, α may be 0.8 and β may be 0.2.

L^{c}=α*L^{p}+β*Lⁱ Equation (2)

In some examples, feedback module 22 may poll users of devices connected to AP 4A for their subjective evaluations of their connection experiences with wireless network A. To poll a particular device, feedback module 22 may output, via communication module 20 and to the particular device, a request to poll the user of the particular device for the user's subjective evaluation of the connection experience with the wireless network. In some examples, feedback module 22 may poll every user of every device connected to AP 4A during every interval. In other examples, feedback module 22 may not poll every user of every device connected to AP 4A during every interval.

In some examples, feedback module 22 may determine the like metric for an interval in accordance with Equation (3), below, where Nₚⁱ is the number of devices polled during interval i, N_{R}ⁱ is the number of devices whose users indicated they liked the connection experience with wireless network A, and Lⁱ is the metric based on feedback during interval i.

$${L}^{i} = \frac{{N}_{R}^{i}}{{N}_{P}^{i}} \qquad Equation ( 3 )$$

Feedback module 22 may update the metric in the look-up table (e.g., Table 3) corresponding to the data load on AP 4A during the interval. For instance, where the data load on AP 4A (rⁱ) is x, the data indicates that the user of the device likes the connection experience with AP 4A, and the distance between AP 4A and the device is a, feedback module 22 may update the metric in the look-up table corresponding to data load x and distance a (i.e., metric e of Table 3) with the result of Equation (2).

In some examples, the metric may be associated with the overall connection experience. However, in accordance with one or more techniques of this disclosure, the metric may be extendible such that the metrics may be associated with experiences with individual services such as streaming, file transfer, web browsing, online gaming, etc. In some examples, feedback module 22 may maintain multiple look-up tables (i.e., databases) for different services. In some examples, feedback module 22 may maintain a look-up table, similar to Table 3, with columns for different services. Table 4, below, is an example of a look-up table that may be maintained by feedback module 22.

TABLE 4

| | | | | Web | Online | File |
|---|---|---|---|---|---|---|
| | Data | Overall | Streaming | Browsing | Gaming | Transfer |
| Distance | Load | Metric | Metric | Metric | Metric | Metric |
| a | x | e | eₛ | e_{wb} | e_{og} | e_{ft} |
| | x + y | e′ | e′ₛ | e′_{wb} | e′_{og} | e′_{ft} |

In some examples, AP 4A may scale the metric. For instance, where the metric is a number of likes, AP 4A may multiply the metric by 1000 such that the metric for a wireless network with 15 likes is 15,000.

One or more storage devices 16 may be configured to store information within AP 4A during operation. One or more of storage devices 16, in some examples, may comprise a computer-readable storage medium. In some examples, one or more of storage devices 16 may comprise a temporary memory, meaning that a primary purpose of one or more of storage devices 16 is not long-term storage. One or more of storage devices 16, in some examples, may comprise a volatile memory, meaning that one or more of storage devices 16 does not maintain stored contents when the system is turned off. Example of volatile memories include random access memories (RAM), dynamic random access memories (DRAM), static random access memories (SRAM), and other forms of volatile memories known in the art. In some examples, one or more of storage devices 16 is used to store program instructions for execution by processor(s) 12. One or more of storage devices 16, in one example, may be used by software or modules running on AP 4A (e.g., communication module 20 and/or feedback module 22) to temporarily store information during program execution.

One or more of storage devices 16, in some examples, may also include one or more computer-readable storage media. One or more of storage devices 16 may further be configured for long-term storage of information. In some examples, one or more of storage devices 16 may include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

FIG. 3 is a block diagram illustrating further details of one example of a device of FIG. 1, in accordance with one or more techniques of this disclosure. As illustrated in FIG. 3, device 8 may include one or more processors 26, one or more communication units 28, one or more user interface (UI) devices 30, and one or more storage devices 32. Each of components 26, 28, 30, and 32 may be interconnected (physically, communicatively, and/or operatively) via communication channels 34 for inter-component communications. In some examples, communication channels 34 may include a system bus, network connection, interprocess communication data structure, or any other channel for communicating data. One or more of storage devices 32, in some examples, may include UI module 36, communication module 38, selection module 40, and one or more application modules 42A-42N (collectively, “application modules 42”).

Processors 26, in one example, are configured to implement functionality and/or process instructions for execution within device 8. For example, processors 26 may be capable of processing instructions stored in one or more of storage devices 32. Examples of processors 26 may include any one or more microprocessors, digital signal processors (DSPs), application specific integrated circuits (ASICs), field programmable gate arrays (FPGAs), or any other equivalent integrated or discrete logic circuitry, as well as any combinations of such components.

Device 8, in some examples, also includes ones or more communication units 28. Device 8, in one example, utilizes one or more of communication units 28 to communicate with external devices via one or more networks, such as one or more wireless networks. One or more of communication units 28 may be a network interface card, such as an Ethernet card, an optical transceiver, a radio frequency transceiver, or any other type of device that can send and receive information. Other examples of such network interfaces may include Bluetooth, cellular, and Wi-Fi radios. In some examples, communication units 28 may include one or more subscriber identity module (SIM) cards (i.e., such that device 8 may be a single, or a multi-SIM device). For instance, communication units 28 may include a first SIM card for a first carrier and a second SIM card for a second carrier. In some examples, device 8 utilizes one or more of communication units 28 to wirelessly communicate with an external device. For instance, device 8 may utilize one or more of communication units 28 to connect to a wireless network hosted by an access point, such as a wireless network hosted by one of more of access points 4 of FIG. 1. In some examples, communication units 28 may receive input from other components of device 8, such as communication module 38, which causes one or more of communication units 28 to wirelessly communicate with an external device.

In some examples, communication module 38 may manage communications between device 8 and an external device, such as an access point. For instance, communication module 38 may enable device 8 to connect to a wireless network hosted by an access point.

Device 8, in some examples, may also include one or more UI devices 30. In some examples, one or more of UI devices 30 can be configured to output content, such as media data. For instance, one or more of UI devices 30 may be configured to display video data at a display and/or output audio data from speakers. In addition to outputting content, one or more of UI devices 30 may be configured to receive tactile, audio, or visual input. Some examples of UI devices 30 include video displays, speakers, keyboards, touch screens, mice, cameras, and the like.

Device 8, in some examples, may also include UI module 36. UI module 36 can perform one or more functions to receive, content, such as UI data from other components associated with device 8 and cause one or more of UI devices 30 to output the content. In some examples, UI module 36 may be configured to receive an indication of input, such as user input, and send the indications of the input to other components associated with device 8, such as selection module 40.

In accordance with one or more techniques of this disclosure, device 8 may include selection module 40, which may be configured to select, or enable a user of device 8 to select, a wireless network of a plurality of wireless networks based on user feedback about connection experiences with the plurality of wireless networks. To enable selection of a wireless network, selection module 40 may be executable by processors 26 to receive, for one or more respective wireless networks of the plurality of wireless networks currently accessible by device 8, a metric based on user feedback about connection experiences with the respective wireless network.

In some examples, selection module 40 may be executable by processors 26 to automatically select a network from the plurality of wireless networks for connection based on the received metrics. For instance, selection module 40 may automatically select the network of the plurality of wireless networks with the metric that indicates the best connection experience.

In some examples, selection module 40 may be executable by processors 26 to enable the user of device 8 to select the network for connection. For instance, selection module 40 may cause UI module 36 to output, via one or more of UI devices 30, a graphical user interface (GUI) including the respective metrics for the one or more wireless networks. As one example, selection module 40 may cause UI module 30 to output a GUI that includes some or all of the information shown above in Table 2. The user of device 8 may review the GUI and provide user input indicating a selection of a particular wireless network of the one or more wireless networks. Selection module 40 may receive, via UI module 36, an indication of the user input and determine the selected network based on the indication.

As discussed above, in some examples, in addition to or in place of a metric associated with an overall connection experience, selection module 40 may receive different metrics for connection experiences with different services. In some of such examples, selection module 40 may cause UI module 30 to output a first GUI with the overall metric value and one or more options to display additional information (e.g., an “about” soft key or a “more” soft key). If the user selects one of the options to display additional information, selection module 40 may cause UI module 30 to output a second GUI with the different metrics for connection experiences with different services. In this way, a user may select a network with the best connection experience for the service the user intends to use.

One or more storage devices 32 may be configured to store information within device 8 during operation. One or more of storage devices 32, in some examples, may comprise a computer-readable storage medium. In some examples, one or more of storage devices 32 may comprise a temporary memory, meaning that a primary purpose of one or more of storage devices 32 is not long-term storage. One or more of storage devices 32, in some examples, may comprise a volatile memory, meaning that one or more of storage devices 32 does not maintain stored contents when the system is turned off. Example of volatile memories include random access memories (RAM), dynamic random access memories (DRAM), static random access memories (SRAM), and other forms of volatile memories known in the art. In some examples, one or more of storage devices 32 is used to store program instructions for execution by processors 26. One or more of storage devices 32, in one example, may be used by software or modules running on device 8 (e.g., UI module 36, communication module 38, selection module 40, and application modules 42) to temporarily store information during program execution.

One or more of storage devices 32, in some examples, may also include one or more computer-readable storage media. One or more of storage devices 32 may further be configured for long-term storage of information. In some examples, one or more of storage devices 32 may include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Each of application modules 42 may represent an application provided by an entity that manufactures device 8 or software operating on device 8 or an application developed by a third-party for use with device 8. Examples of application modules 42 may include applications for travel routing, maps, audio and/or video presentation, streaming video delivery and presentation, word processing, spreadsheets, voice and/or calls, weather updates, etc.

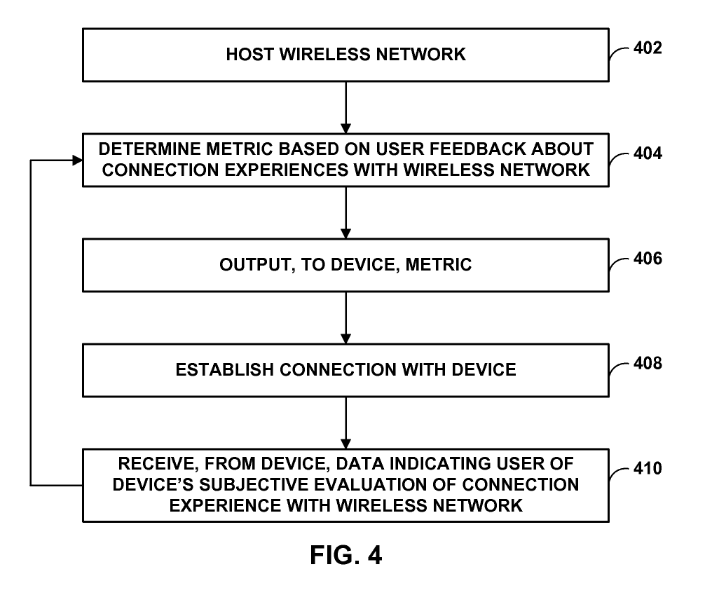

FIG. 4 is a flow diagram illustrating example operations of an access point to enable a device to connect to a wireless network hosted by the access point based on user feedback about connection experiences with the wireless network, in accordance with one or more techniques of this disclosure. The techniques of FIG. 4 may be performed by one or more processors of an access point, such as AP 4A illustrated in FIGS. 1 and 2. For purposes of illustration, the techniques of FIG. 4 are described within the context of AP 4A illustrated in FIGS. 1 and 2, although access points having configurations different than that of AP 4A may perform the techniques of FIG. 4.

As illustrated in FIG. 4, AP 4A may host a wireless network (402). For instance, processors 12 of access point 4A may execute communication module 20 of access point 4A to host wireless network A. As discussed above, wireless network A may be a Wi-Fi network, a cellular network, or any other type of wireless network. In some examples, access point 4A may host wireless network A such that devices connected to wireless network A may utilize resources connected to networks other than wireless network A, such as the Internet.

As discussed above, in some examples, it may be desirable for a device to select, or enable a user of the device to select, a wireless network based on more than just signal strength. In accordance with one or more techniques of this disclosure, AP 4A may determine a metric based on user feedback about connection experiences with the wireless network hosted by AP 4A (404). For instance, processors 12 may execute feedback module 22 of AP 4A to determine the metric. As discussed above, the metric may be in the form of a number of likes, a number of dislikes, a 1-N (e.g., 1-5) scale, or any other such rating system. In some examples, AP 4A may determine the metric by actually calculating the metric based on user feedback. In other examples, the metric may be calculated by another device (e.g., a server) and AP 4A may determine the metric by receiving the metric from the other device.

In some examples, AP 4A may determine the metric based on one or more variables in addition to the user feedback. As one example, AP 4A may determine the metric based on user feedback and a distance between the device and AP 4A.

AP 4A may output the metric to a device (406). For instance, processors 12 may execute feedback module 22 to wirelessly transmit the metric to a device, such as device 8 of FIGS. 1 and 3, via one or more of communication units 14 of AP 4A. In some examples, AP 4A may output the metric to the device in response to receiving a request, such as a probe request, from the device. For instance, where wireless network A is a Wi-Fi network, AP 4A may output the metric to the device in a probe response that also includes a service set identification (SSID) of wireless network A.

AP 4A may establish a connection with the device (408). For instance, processors 12 may execute communication module 20 to establish a connection with the device and wireless network A.

While the device is connected, AP 4A may receive, from the device, data indicating a user of the device's subjective evaluation of a connection experience with the wireless network hosted by AP 4A (410). For instance, processors 12 may execute feedback module 22 to receive, via communication module 20 and one or more of communication units 14, the user feedback (i.e., the user of the device's subjective evaluation of a connection experience with wireless network A). In some examples, prior to receiving the data, AP 4A may output, to the device, a request to poll the user of the device for the user's subjective evaluation of the connection experience with the wireless network. In this way, AP 4A may actively request user feedback from the device.

AP 4A may update the metric based on the received data (returning to 404). For instance, where the data indicates that the user of the device likes the connection experience and the metric is a number of likes, processors 12 may execute feedback module 22 to update the metric by incrementing the number of likes. In this way, AP 4A may maintain a metric based on user feedback about connection experiences with a wireless network hosted by AP 4A.

In some examples, after establishing a connection with the device, AP 4A may update the metric output to the device. For instance, where AP 4A determines the metric based on one or both of a data load on AP 4A and distance between AP 4A and the device, AP 4A may output an updated metric to the device where one or both of the data load and the distance have changed. Table 5 shows some example conditions under which AP 4A may output an updated metric value to the device.

TABLE 5

| | | Data Load | |
|---|---|---|---|
| | | No change | Change |
| Distance | No change | Metric value unchanged | Metric value changed, |
| | | | device updated |
| | Change | Metric value changed, | Metric value changed, |
| | | device updated | device updated |

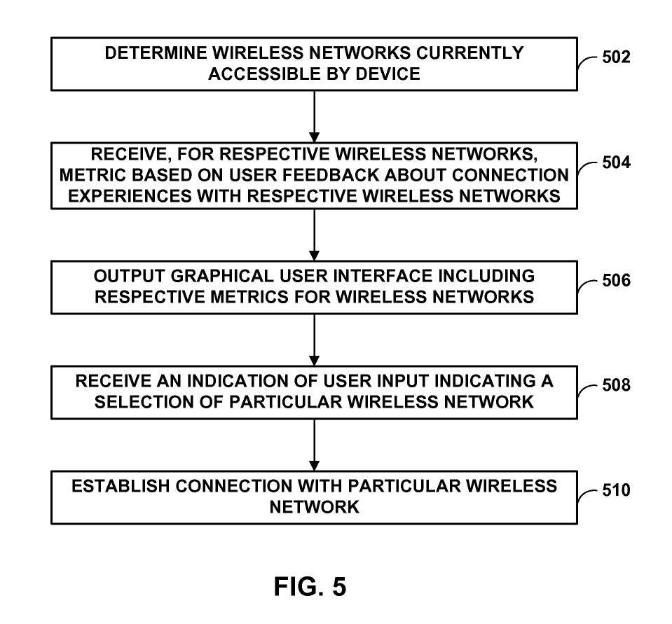

FIG. 5 is a flow diagram illustrating example operations of a device to connect to a wireless network hosted by an access point based on user feedback about connection experiences with the wireless network, in accordance with one or more techniques of this disclosure. The techniques of FIG. 5 may be performed by one or more processors of a device, such as device 8 illustrated in FIGS. 1 and 3. For purposes of illustration, the techniques of FIG. 5 are described within the context of device 8 illustrated in FIGS. 1 and 3, although access points having configurations different than that of device 8 may perform the techniques of FIG. 5.

As illustrated by FIG. 5, device 8 may determine a plurality of wireless networks currently accessible by device 8 (502). For instance, processors 26 may execute communication module 38 to scan, via one of more of communication units 28, for wireless networks currently accessible by device 8.

In accordance with one or more techniques of this disclosure, device 8 may receive, for one or more respective wireless networks of the plurality of wireless networks, a metric based on user feedback about connection experiences with the respective wireless network (504). As discussed above, in some examples, device 8 may receive the metrics for the one or more respective wireless networks from respective access points of the wireless networks.

As discussed above, in some examples, device 8 may automatically select a wireless network for connection. In other examples, device 8 may enable a user of device 8 to select a wireless network for connection. For instance, device 8 may output a graphical user interface (GUI) including the respective metrics for the one or more wireless networks (506). For instance, processors 26 may execute selection module 40 to output, via UI module 30, a GUI that includes some or all of the information shown above in Table 2, such as a name, a type, and the metric for each network. In some examples, device 8 may not receive a metric for each of the currently accessible wireless networks. In such examples, the metric portion of the GUI output by selection module 40 may be blank, or otherwise indicate that a metric was not received for networks for which a metric is not received.

Device 8 may receive an indication of user input, the user input indicating a selection of a particular wireless network of the one or more wireless networks. For instance, processors 26 may execute UI module 36 to receive, via one or more of UI devices 30, the indication of user input (e.g., the user may click or tap on a portion of the GUI corresponding to the particular network).

In any case, device 8 may establish a connection with the particular wireless network (510). For instance, processors 26 may execute communication module 38 to establish a connection with the access point hosting the selected wireless network.

Device 8 may enable the user to provide feedback of their subjective evaluation of the connection experience with the particular wireless network. For instance, device 8 may output a GUI including a prompt for the user of device 8 to provide user input regarding a connection experience with the particular wireless network. As one example, processors 26 may execute selection module 40 to output, via UI module 36, a GUI with the prompt “Do you like the connection experience with the current wireless network?” along with Yes and No buttons.

In some examples, device 8 may automatically output the prompt after being connected to the particular wireless network for a period of time. In some examples, device 8 may output the prompt in response to receiving a request from the access point of the particular wireless network to poll the user of the device for the user's subjective evaluation of the connection experience with the particular wireless network.

Device 8 may receive an indication of user input, the user input indicating the user's subjective evaluation of the connection experience with the particular wireless network. For instance, processors 26 may execute UI module 36 to receive, via one or more of UI devices 30, the indication of user input (e.g., the user may click or tap on a portion of the GUI corresponding to the Yes button or the No button).

Device 8 may output, to an access point of the currently connected wireless network, data indicating the device user's subjective evaluation of the connection experience with the particular wireless network. For instance, where the user clicked or tapped on the Yes button, device 8 may output data indicating that the user liked the connection experience with the particular wireless network.

As discussed above, in some examples, after establishing a connection with the particular wireless network, one or more conditions on which the metric was determined may change. For instance, where the metric is determined based on one or both of a data load on the wireless network and distance between device 8 and the access point of the wireless network, device 8 may receive an updated metric where one or both of the data load and the distance have changed. As one example, device 8 may receive first metrics for the one or more wireless networks at a first time. After the first time, the distance between device 8 and the access points and/or the data loads on the access points of the one or more wireless networks may change. Device 8 may receive second metrics for the one or more respective wireless networks at a second time that is after the first time.

In some examples, a second metric for at least one wireless network of the one or more wireless networks may be different than a first metric for the at least one wireless network. For instance, where device 8 connected to the wireless network with the best first metric at the first time, a second metric for another wireless network may be greater (i.e., indicate a better connection experience) than a second metric for the wireless network that had the best first metric at the first time.

In some examples, device 8 may automatically switch wireless networks based on changes in the received metrics. For instance, where device 8 is currently connected to a particular wireless network, in response to determining that a second metric for a different wireless network of the one or more wireless networks is greater than a second metric for the particular wireless network, device 8 may automatically establish a connection with the different wireless network (and may terminate the connection with the particular wireless network).

In some examples, device 8 may enable the user of device 8 to determine whether to switch networks based on changes in the received metrics. For instance, device 8 may output an updated GUI including the updated metrics for the one or more wireless networks. As one example, device 8 may output the GUI with an indication of the updated metrics in a task bar portion of the GUI.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

The following numbered examples may illustrate one or more aspects of the disclosure.

### Example 1

A method for enabling selection of a wireless network, the method comprising: determining, by a device, a plurality of wireless networks currently accessible by the device; receiving, by the device and for one or more respective wireless networks of the plurality of wireless networks, a metric based on user feedback about connection experiences with the respective wireless network; outputting, by the device, a graphical user interface (GUI) including the respective metrics for the one or more wireless networks; receiving, by the device, an indication of user input, the user input indicating a selection of a particular wireless network of the one or more wireless networks; and establishing, by the device, a connection with the particular wireless network.

### Example 2

The method of example 1, further comprising: outputting, by the device, a GUI including a prompt for a user of the device to provide user input regarding a connection experience with the particular wireless network; receiving, by the device, an indication of user input, the user input indicating the user's subjective evaluation of the connection experience with the particular wireless network; and outputting, by the device and to an access point of the particular wireless network, data indicating the user's subjective evaluation of the connection experience with the particular wireless network.

### Example 3

The method of any combination of examples 1-2, the method further comprising: receiving, by the device an updated metric for the particular wireless network, wherein the updated metric is based at least in part on the data indicating the user's subjective evaluation of the connection experience with the particular wireless network.

### Example 4

The method of any combination of examples 1-3, further comprising: receiving, by the device and from the access point of the particular wireless network, a request to poll the user of the device for the user's subjective evaluation of the connection experience with the particular wireless network, wherein outputting the GUI including the prompt comprises outputting the GUI in response to receiving the request to poll the user of the device.

### Example 5

The method of any combination of examples 1-4, wherein the received metrics for the one or more respective wireless networks are further based on one or both of: a distance between the device and an access point of the respective wireless network, and a data load on the respective wireless network.

### Example 6

The method of any combination of examples 1-5, wherein receiving the metrics for the one or more respective wireless networks comprises receiving first metrics for the one or more respective wireless networks at a first time, the method further comprising: receiving, by the device, second metrics for the one or more respective wireless networks at a second time that is after the first time, wherein a second metric for at least one wireless network of the one or more wireless networks is different than a first metric for the at least one wireless network.

### Example 7

The method of any combination of examples 1-6, further comprising: in response to determining that a second metric for a different wireless network of the one or more wireless networks is greater than a second metric for the particular wireless network, automatically establishing, by the device, a connection with the different wireless network.

### Example 8

The method of any combination of examples 1-7, wherein each of the plurality of wireless networks is either a Wi-Fi network or a cellular network.

### Example 9

The method of any combination of examples 1-8, wherein receiving the metrics for the one or more respective wireless networks comprises receiving a plurality of metrics for the one or more respective wireless networks based on user feedback about connection experiences with the respective wireless network for a plurality of different services.

### Example 10

A device comprising: one or more wireless communication modules; and one or more processors configured to perform the method of any combination of examples 1-9.

### Example 11

A method for enabling selection of a wireless network, the method comprising: outputting, to a device and by an access point of a wireless network currently accessible by the device, a metric based on user feedback about connection experiences with the wireless network.

### Example 12

The method of example 11, further comprising: establishing, by the access point, a connection with the device; and receiving, by the access point and from the device, data indicating a user's subjective evaluation of the connection experience with the wireless network.

### Example 13

The method of any combination of examples 11-12, further comprising: outputting, by the access point and to the device, a request to poll the user of the device for the user's subjective evaluation of the connection experience with the wireless network, wherein the data indicating the user's subjective evaluation of the connection experience with the wireless network is received after outputting the request to poll the user of the device.

### Example 14

The method of any combination of examples 11-13, further comprising: updating the metric based on the data indicating the user's subjective evaluation of the connection experience with the wireless network.

### Example 15

The method of any combination of examples 11-14, wherein the metric is determined based on one or both of: a distance between the device and the access point, and a data load on the wireless network.

### Example 16

The method of any combination of examples 11-15, wherein outputting the metric for the wireless network comprises outputting a first metric for the wireless network at a first time, the method further comprising: in response to determining that one or both of the distance and the data load have changed, outputting, to the device and at a second time that is later than the first time, a second metric for the wireless network, the second metric based on user feedback about connection experiences with the wireless network and one or both of the changed distance and data load.

### Example 17

The method of any combination of examples 11-16, wherein outputting the metric to the device comprises outputting a plurality of metrics based on user feedback about connection experiences with the wireless network for a plurality of different services.

### Example 18

A wireless access point comprising: one or more wireless communication modules; and one or more processors configured to: host, via the one or more wireless communication modules, a wireless network that is currently accessible by a device; and perform the method of any combination of examples 11-17.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for enabling selection of a wireless network, the method comprising:
determining, by a device, a plurality of wireless networks currently accessible by the device;
receiving, by the device and for one or more respective wireless networks of the plurality of wireless networks, a metric based on user feedback about connection experiences with the respective wireless network;
outputting, by the device, a graphical user interface (GUI) including the respective metrics for the one or more wireless networks;
receiving, by the device, an indication of user input, the user input indicating a selection of a particular wireless network of the one or more wireless networks; and
establishing, by the device, a connection with the particular wireless network.

2. The method of claim 1, further comprising:
outputting, by the device, a GUI including a prompt for a user of the device to provide user input regarding a connection experience with the particular wireless network;
receiving, by the device, an indication of user input, the user input indicating the user's subjective evaluation of the connection experience with the particular wireless network; and
outputting, by the device and to an access point of the particular wireless network, data indicating the user's subjective evaluation of the connection experience with the particular wireless network.

3. The method of claim 2, the method further comprising:
receiving, by the device an updated metric for the particular wireless network, wherein the updated metric is based at least in part on the data indicating the user's subjective evaluation of the connection experience with the particular wireless network.

4. The method of claim 2, further comprising:
receiving, by the device and from the access point of the particular wireless network, a request to poll the user of the device for the user's subjective evaluation of the connection experience with the particular wireless network,
wherein outputting the GUI including the prompt comprises outputting the GUI in response to receiving the request to poll the user of the device.

5. The method of claim 1, wherein the received metrics for the one or more respective wireless networks are further based on one or both of:
a distance between the device and an access point of the respective wireless network, and
a data load on the respective wireless network.

6. The method of claim 1, wherein receiving the metrics for the one or more respective wireless networks comprises receiving first metrics for the one or more respective wireless networks at a first time, the method further comprising:
receiving, by the device, second metrics for the one or more respective wireless networks at a second time that is after the first time, wherein a second metric for at least one wireless network of the one or more wireless networks is different than a first metric for the at least one wireless network.

7. The method of claim 6, further comprising:
in response to determining that a second metric for a different wireless network of the one or more wireless networks is greater than a second metric for the particular wireless network, automatically establishing, by the device, a connection with the different wireless network.

8. The method of claim 1, wherein each of the plurality of wireless networks is either a Wi-Fi network or a cellular network.

9. The method of claim 1, wherein receiving the metrics for the one or more respective wireless networks comprises receiving a plurality of metrics for the one or more respective wireless networks based on user feedback about connection experiences with the respective wireless network for a plurality of different services.

10. A device comprising:
one or more wireless communication modules; and
one or more processors configured to:
determine a plurality of wireless networks currently accessible by the device;
receive, for one or more respective wireless networks of the plurality of wireless networks, a metric based on user feedback about connection experiences with the respective wireless network;
output a graphical user interface (GUI) including the respective metrics for the one or more wireless networks;
receive an indication of user input, the user input indicating a selection of a particular wireless network of the one or more wireless networks; and
establish a connection with the particular wireless network.

11. The device of claim 10, wherein the one or more processors are further configured to:
output a GUI including a prompt for a user of the device to provide user input regarding a connection experience with the particular wireless network;
receive an indication of user input, the user input indicating the user's subjective evaluation of the connection experience with the particular wireless network; and
output, to an access point of the particular wireless network, data indicating the user's subjective evaluation of the connection experience with the particular wireless network.

12. The device of claim 11, wherein the one or more processors are further configured to:
receive, from the access point of the particular wireless network, a request to poll the user of the device for the user's subjective evaluation of the connection experience with the particular wireless network; and
output the GUI including the prompt in response to receiving the request to poll the user of the device.

13. The device of claim 11, wherein the received metrics for the one or more respective wireless networks are further based on one or both of:
a distance between the device and an access point of the respective wireless network, and
a data load on the respective wireless network.

14. The device of claim 10, wherein, to receive the metrics for the one or more respective wireless networks, the one or more processors are configured to receive first metrics for the one or more respective wireless networks at a first time, and wherein the one or more processors are further configured to:
receive second metrics for the one or more respective wireless networks at a second time that is after the first time, wherein a second metric for at least one wireless network of the one or more wireless networks is different than a first metric for the at least one wireless network.

15. The device of claim 14, wherein the one or more processors are further configured to:
in response to determining that a second metric for a different wireless network of the one or more wireless networks is greater than a second metric for the particular wireless network, automatically establish a connection with the different wireless network.

16. The device of claim 10, wherein receiving the metrics for the one or more respective wireless networks comprises receiving a plurality of metrics for the one or more respective wireless networks based on user feedback about connection experiences with the respective wireless network for a plurality of different services.

17. A method for enabling selection of a wireless network, the method comprising:
outputting, to a device and by an access point of a wireless network currently accessible by the device, a metric based on user feedback about connection experiences with the wireless network.

18. The method of claim 17, further comprising:
establishing, by the access point, a connection with the device; and
receiving, by the access point and from the device, data indicating a user's subjective evaluation of the connection experience with the wireless network.

19. The method of claim 18, further comprising:
outputting, by the access point and to the device, a request to poll the user of the device for the user's subjective evaluation of the connection experience with the wireless network,
wherein the data indicating the user's subjective evaluation of the connection experience with the wireless network is received after outputting the request to poll the user of the device.

20. The method of claim 18, further comprising:
updating the metric based on the data indicating the user's subjective evaluation of the connection experience with the wireless network.

21. The method of claim 17, wherein the metric is determined based on one or both of:
a distance between the device and the access point, and
a data load on the wireless network.

22. The method of claim 21, wherein outputting the metric for the wireless network comprises outputting a first metric for the wireless network at a first time, the method further comprising:
in response to determining that one or both of the distance and the data load have changed, outputting, to the device and at a second time that is later than the first time, a second metric for the wireless network, the second metric based on user feedback about connection experiences with the wireless network and one or both of the changed distance and data load.

23. The method of claim 17, wherein outputting the metric to the device comprises outputting a plurality of metrics based on user feedback about connection experiences with the wireless network for a plurality of different services.

24. A wireless access point comprising:
one or more wireless communication modules; and
one or more processors configured to:
host, via the one or more wireless communication modules, a wireless network that is currently accessible by a device; and
output, to the device and via the one or more wireless communication modules, a metric based on user feedback about connection experiences with the wireless network.

25. The wireless access point of claim 24, wherein the one or more processors are further configured to:
establish a connection with the device; and
receive, from the device, data indicating a user's subjective evaluation of the connection experience with the wireless network.

26. The wireless access point of claim 25, wherein the one or more processors are further configured to:
output, to the device, a request to poll the user of the device for the user's subjective evaluation of the connection experience with the wireless network; and
receive the data indicating the user's subjective evaluation of the connection experience with the wireless network after outputting the request to poll the user of the device.

27. The wireless access point of claim 25, wherein the one or more processors are further configured to:
update the metric based on the data indicating the user's subjective evaluation of the connection experience with the wireless network.

28. The wireless access point of claim 24, wherein the metric is determined based on one or both of:
a distance between the device and the access point, and
a data load on the wireless network.

29. The wireless access point of claim 28, wherein, to output the metric for the wireless network, the one or more processors and configured to output a first metric for the wireless network at a first time, and wherein the one or more processors are further configured to:
in response to determining that one or both of the distance and the data load have changed, output, to the device and at a second time that is later than the first time, a second metric for the wireless network, the second metric based on user feedback about connection experiences with the wireless network and one or both of the changed distance and data load.

30. The wireless access point of claim 24, wherein, to output the metric to the device, the one or more processors are configured to output a plurality of metrics based on user feedback about connection experiences with the wireless network for a plurality of different services.
